(19) United States
(12) Patent Application Publication
(10) Pub. No.: US 2016/0059518 A1
(43) Pub. Date: Mar. 3, 2016

(54) MAGNET, MAGNET LAMINATION, METHOD FOR PRODUCING LAMINATION MAGNET, AND PRODUCTION SYSTEM FOR LAMINATION MAGNET

(71) Applicant: KABUSHIKI KAISHA YASKAWA DENKI, Kitakyushu-shi (JP)

(72) Inventors: Masahito FUKUNAGA, Kitakyushu-shi (JP); Kanta Yamaguchi, Kitakyushu-shi (JP); Taiki Kimura, Kitakyushu-shi (JP)

(73) Assignee: KABUSHIKI KAISHA YASKAWA DENKI, Kitakyushu-shi (JP)

(21) Appl. No.: 14/836,121

(22) Filed: Aug. 26, 2015

(30) Foreign Application Priority Data
Aug. 28, 2014 (JP) 2014-174454

(51) Int. Cl. B32B 7/12; B32B 37/26; B32B 37/18

(52) U.S. Cl. CPC B32B 7/12; B32B 37/18; B32B 37/26; B32B 2457/00; B32B 2307/208; B32B 2255/26

(57) ABSTRACT

A magnet is applicable to a movable electrical machine and includes a plurality of resin protrusions at a plurality of positions on a surface of the magnet.

### CROSS-REFERENCE TO RELATED APPLICATIONS

The present application claims priority under 35 U.S.C. §119 to Japanese Patent Application No. 2014-174454, filed Aug. 28, 2014. The contents of this application are incorporated herein by reference in their entirety.

### BACKGROUND

1. Field of the Invention

The embodiments disclosed herein relate to a magnet, a magnet lamination, a method for producing a magnet lamination, and a production system for a magnet lamination.

2. Discussion of the Background

Japanese Unexamined Patent Application Publication No. 63-18950 discloses a permanent magnet rotor made up of a predetermined number of laminated magnet cores. Each of the magnet cores has an electrical insulator at least on one surface of the magnet core. The electrical insulator is an insulation coating hardened under pressure and heat.

### SUMMARY

According to one aspect of the present disclosure, a magnet is applicable to a movable electrical machine and includes a plurality of resin protrusions at a plurality of positions on a surface of the magnet.

According to another aspect of the present disclosure, a magnet lamination is applicable to a movable electrical machine, and includes a plurality of laminated magnets, a binder layer, and a plurality of spacers. The binder layer is made of a first resin and disposed between adjacent magnets among the plurality of magnets to bind the adjacent magnets to each other. The plurality of spacers are each made of a second resin disposed at a plurality of positions between the adjacent magnets to define a thickness of the binder layer in a direction in which the plurality of magnets are laminated.

According to another aspect of the present disclosure, a method is for producing a magnet lamination applicable to a movable electrical machine. The method includes applying a first binder to a plurality of positions on a surface of a first magnet. The first binder is hardened. The hardened first binder is processed into a predetermined shape to form a spacer. A second binder is applied to the surface of the first magnet. A second magnet is placed on the surface of the first magnet to form a lamination of the first magnet and the second magnet, and pressure is applied on the lamination. The second binder between the first magnet and the second magnet is hardened.

According to the other aspect of the present disclosure, a production system is for a magnet lamination applicable to a movable electrical machine. The production system includes a first applier, a first hardener, a processor, a second applier, a pressurizer, and a second hardener. The first applier is configured to apply a first binder to a plurality of positions on a surface of a first magnet. The first hardener is configured to harden the first binder. The processor is configured to process the hardened first binder into a predetermined shape so as to form a spacer. The second applier is configured to apply a second binder to the surface of the first magnet. The pressurizer is configured to place a second magnet on the surface of the first magnet so as to form a lamination of the first magnet and the second magnet, and is configured to apply pressure to the lamination. The second hardener is configured to harden the second binder between the first magnet and the second magnet.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1A illustrates an exemplary configuration of a magnet according to an embodiment and an exemplary method for producing the magnet;

FIG. 1B is a continuation of the exemplary configuration of the magnet according to the embodiment and the exemplary method for producing the magnet.

FIG. 1C is a continuation of the exemplary configuration of the magnet according to the embodiment and the exemplary method for producing the magnet.

FIG. 1D is a continuation of the exemplary configuration of the magnet according to the embodiment and the exemplary method for producing the magnet.

FIG. 1E illustrates an exemplary configuration of a magnet lamination according to an embodiment and an exemplary method for producing the magnet lamination;

FIG. 1F is a continuation of the exemplary configuration of the magnet lamination according to the embodiment and the exemplary method for producing the magnet lamination;

FIG. 1G is a continuation of the exemplary configuration of the magnet lamination according to the embodiment and the exemplary method for producing the magnet lamination;

FIG. 2A is a side view of an exemplary shape of a protrusion;

FIG. 2B is a side view of an exemplary shape of a spacer;

FIG. 3A schematically illustrates exemplary processing marks resulting from cutting;

FIG. 3B schematically illustrates exemplary processing marks resulting from grinding;

FIG. 4 is a diagram illustrating an exemplary configuration of a production system for the magnet lamination;

FIG. 5 is a flowchart that details an example of control performed by a controller of the production system for the magnet lamination;

FIG. 6A is a side view of a spacer according to a modification illustrating an exemplary shape of the spacer;

FIG. 6B is a perspective view of the spacer according to the modification;

FIG. 7A is a side view of a spacer according to another modification illustrating an exemplary shape of the spacer;

FIG. 7B is a perspective view of the spacer according to the another modification;

FIG. 8A is a plan view of spacers according to a modification illustrating the number and arrangement of the spacers; and

FIG. 8B is a plan view of spacers according to another modification illustrating the number and arrangement of the spacers.

### DESCRIPTION OF THE EMBODIMENTS

The embodiments will now be described with reference to the accompanying drawings, wherein like reference numerals designate corresponding or identical elements throughout the various drawings. In the following description, directions are used such as upward direction, downward direction, left direction, and right direction to facilitate understanding of the configuration of the magnet lamination and related devices. These directions, however, should not be construed as limiting the position relationship between the magnet lamination and related devices.

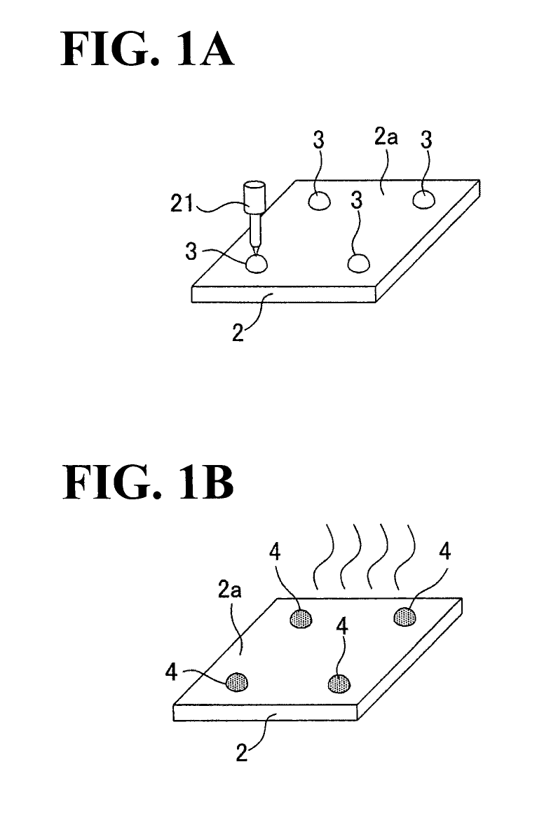

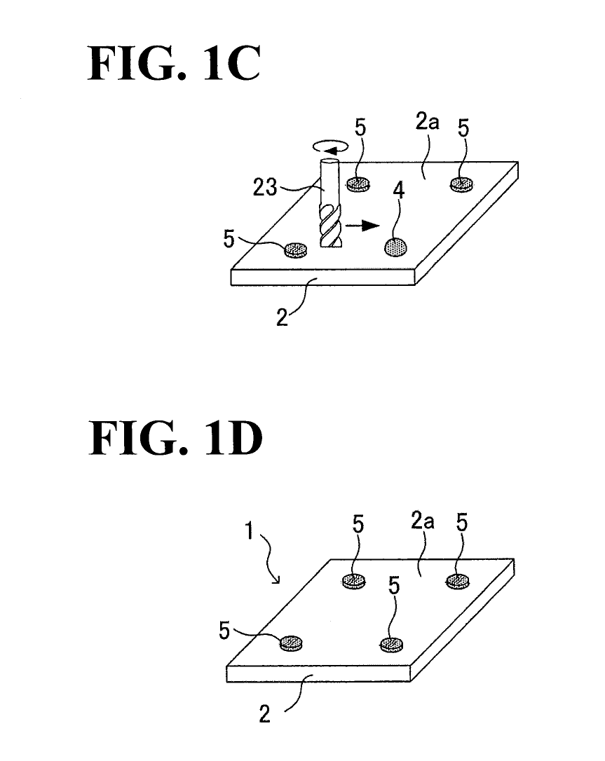

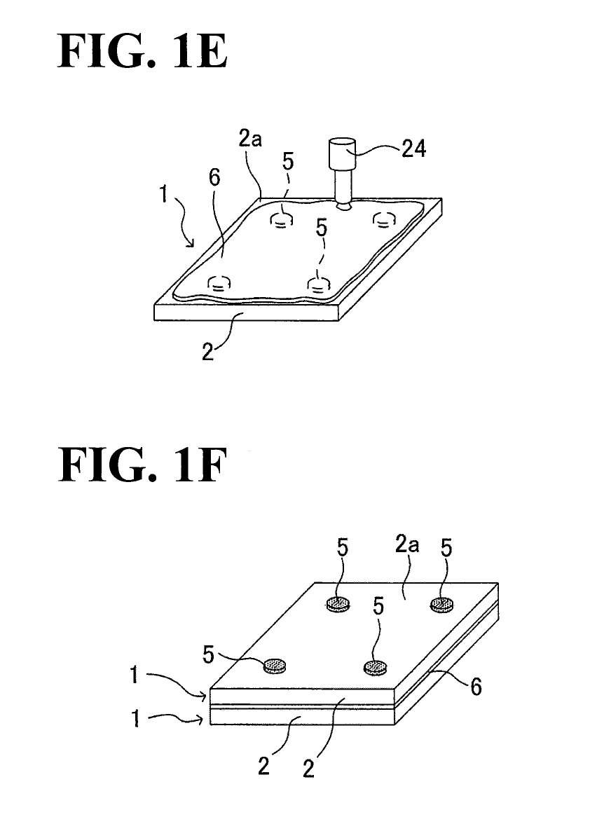

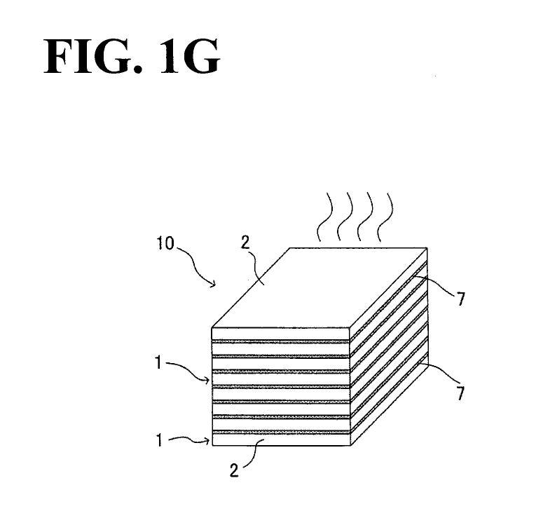

By referring to FIG. 1, a configuration of a magnet and a configuration of a magnet lamination according to this embodiment will be described together with a method for producing the magnet and the magnet lamination. A magnet 1 and a magnet lamination 10 are used as, for example, a field magnet of a movable electrical machine. As used herein, the term movable electrical machine encompasses rotary motors, rotary electric generators, linear motors, and linear electric generators.

### 1. Magnet

The magnet 1 and a method for producing the magnet 1 will be described by referring to FIGS. 1A to 1D.

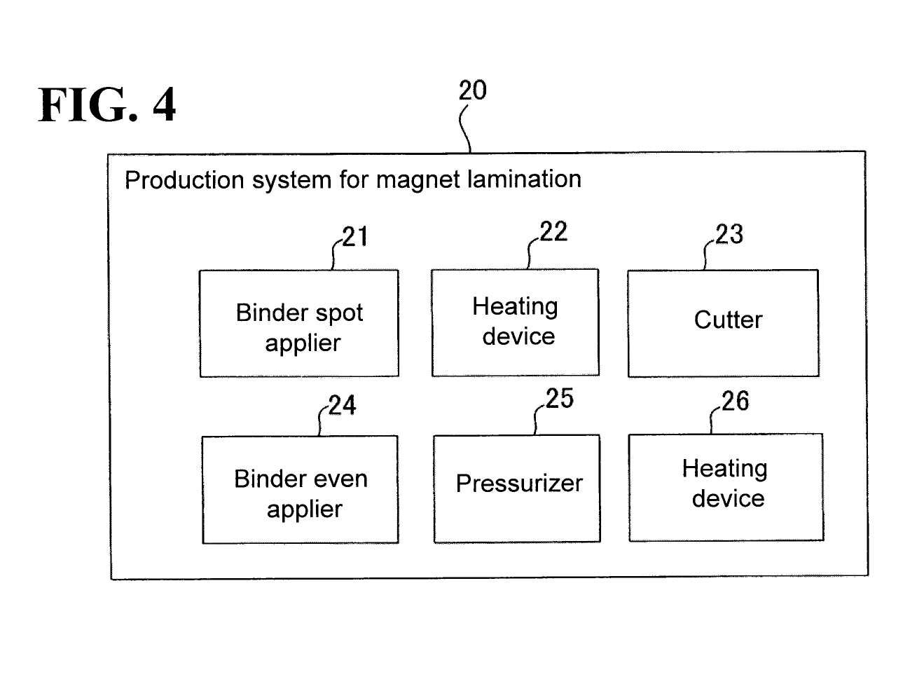

First, as illustrated in FIG. 1A, a binder spot applier 21 (see FIG. 4) applies a binder 3 (corresponding to the first binder) in a spotted manner to one surface 2a of a magnet plate 2. The magnet plate 2 may have any desired shape, which is rectangular in this embodiment. The one surface 2a of the magnet plate 2 is the upper surface in the embodiment illustrated in FIG. 1A. The binder 3 is applied to a plurality of positions on the one surface 2a of the magnet plate 2; for example, positions respectively adjacent to the four corners the one surface 2a. There is no particular limitation to the kind of the binder 3. Examples of the binder 3 include, but are not limited to, resin adhesives such as one-part thermosetting epoxy resins.

Next, as illustrated in FIG. 1B, the binder 3 applied to the magnet plate 2 is hardened, resulting in protrusions 4. There is no particular limitation to the method of hardening the binder 3. A possible example in the case where the binder 3 is a thermosetting binder as described above is to use a heating device 22 (see FIG. 4), which has a furnace. In this case, the magnet plate 2 to which the binder 3 is applied is put into the furnace of the heating device 22 and heated at a predetermined temperature for a predetermined period of time. Thus, the binder 3 is hardened.

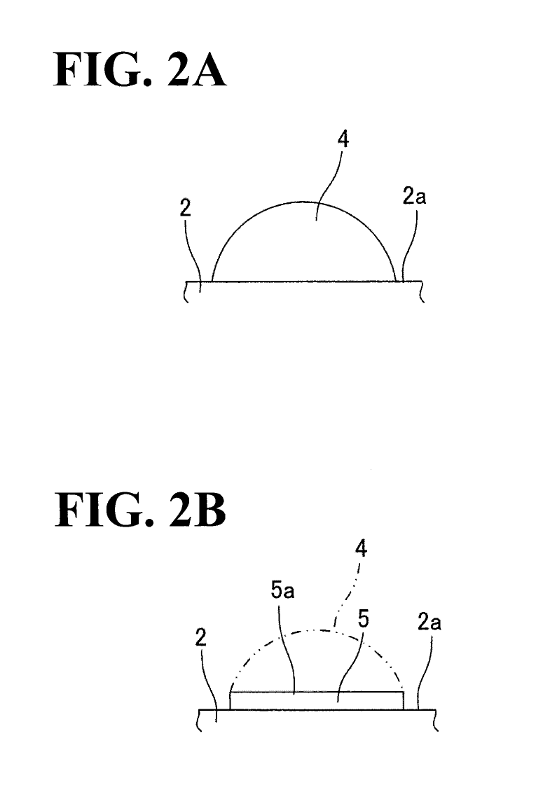

In this manner, the protrusions 4 are formed. The resin of which the protrusions 4 are made corresponds to the second resin. An exemplary shape of each of the protrusions 4 is illustrated in FIG. 2A. In this embodiment, each protrusion 4 has an approximately hemispherical shape, which is due to the surface tension of the binder 3.

Next, as illustrated in FIG. 1C, a cutter 23 (an example is an end mill) cuts the protrusions 4 to a predetermined height as measured from the one surface 2a. All the protrusions 4 on the one surface 2a undergo the cutting to be formed into protrusions 5. The protrusions 5 protrude to the same heights. The protrusions 5 function as spacers to define the thickness of the binder layers, described later, of the magnet lamination 10 in the direction in which the plurality of magnets are laminated. In this context, the protrusions 5 may hereinafter occasionally be referred to as “spacers 5”.

An exemplary shape of each of the protrusions 5 is illustrated in FIG. 2B. Each protrusion 5 has an approximately circular plate shape that has a predetermined height from the one surface 2a of the magnet plate 2. The upper end of each protrusion 5 is a flat portion 5a. On the flat portion 5a, a processing mark resulting from cutting is formed, which will be detailed later. It is possible to use a grinding device (grinder), instead of the cutter 23, to grind the protrusions 4 in order to form the protrusions 5.

Thus, the magnet 1 illustrated in FIG. 1D is prepared. The magnet 1 has a plurality of protrusions 5 (four protrusions 5 in this embodiment) made of resin at a plurality of positions (four positions in this embodiment) on the one surface 2a of the magnet plate 2. It is possible to prepare a necessary number of magnets 1 before the magnet lamination 10 is produced or every time a magnet lamination 10 is produced.

While the protrusions 5 have been described as being formed only on one surface of the magnet plate 2, it is possible to form the protrusions 5 on two or more surfaces of the magnet plate 2 (for example, on the upper and lower surfaces of the magnet plate 2).

### 2. Magnet Lamination

Next, the magnet lamination 10 and a method for producing the magnet lamination 10 will be described by referring to FIGS. 1E to 1G.

As illustrated in FIG. 1E, a binder even applier 24 applies a binder 6 (corresponding to the second binder) in an even manner over the one surface 2a on which the spacers 5 (the protrusions 5) of the magnet 1 are formed. There is no particular limitation to the area over which the binder 6 is applied. Examples of the area include, but are not limited to, an approximately entire area of the one surface 2a and an area over which all of the plurality of spacers 5 are covered in the surface direction of the one surface 2a. There is no particular limitation to the thickness (thickness in the direction in which the plurality of magnets are laminated) of application of the binder 6. Examples of the thickness include, but are not limited to, a thickness beyond the spacers 5 in the direction in which the plurality of magnets are laminated (that is, a thickness greater than the height of the spacers 5).

There is no particular limitation to the kind of the binder 6. Examples of the binder 6 are similar to the binder 3 and include, but are not limited to, resin adhesives such as one-part thermosetting epoxy resins. The binder 6 may be of the same kind as the binder 3 or of a kind different from the binder 3.

Next, as illustrated in FIG. 1F, a new magnet 1 is superposed onto the binder 6 applied on the old magnet 1. Thus, the new magnet 1 is laminated on the old magnet 1 through the binder 6. Then, a pressurizer 25 (see FIG. 4) applies pressure to the lamination of the two magnets 1 to compress the lamination in the directions in which the two magnets 1 are laminated. The pressurizer 25 has a pair of pressure holders. The pressure causes the binder 6 to be pressed, making the distance between the two magnets 1 approximately the same as the thickness of the spacers 5.

By repeating the steps illustrated in FIGS. 1E and 1F, any desired number of magnets 1 are laminated on top of each other. Then, as illustrated in FIG. 1G, the binders 6 between the laminated magnets 1 are hardened into binder layers 7 made of resin (corresponding to the first resin). Each of the binder layers 7 binds adjacent magnets 1 and covers the plurality of spacers 5. There is no particular limitation to the method of hardening the binders 6. A possible example in the case where the binder 6 is a thermosetting binder as described above is to use a heating device 26 (see FIG. 4), which has a furnace. In this case, the plurality of magnets 1 laminated on top of each other through the binder 6 are put into the furnace of the heating device 26 and heated at a predetermined temperature for a predetermined period of time. Thus, the binder 6 is hardened. It is possible to replace the heating device 26 with the heating device 22.

Thus, the magnet lamination 10 is produced. The magnet lamination 10 includes the plurality of (eight in this embodiment) laminated magnets 1, the binder layers 7, and the plurality of spacers 5. The binder layers 7 are each made of resin and disposed between adjacent magnets 1 to bind the adjacent magnets 1. The plurality of spacers 5 are disposed at a plurality of positions between adjacent magnets 1 and define the thickness of the binder layers 7 in the direction in which the plurality of magnets 1 are laminated. The magnet lamination 10 may be used in a movable electrical machine without being processed into some other shape. As necessary, the magnet lamination 10 may be cut or processed in some other manner into a desired shape to be used in a movable electrical machine.

In the embodiment illustrated in FIG. 1G, the last magnet 1 (uppermost magnet 1 in FIG. 1G) in the magnet lamination 10 is bound to a magnet plate 2 on which no spacers 5 are formed. The last magnet 1 may be bonded to a magnet 1 on which spacers 5 are formed.

### 3. Processing Mark on Flat Portion

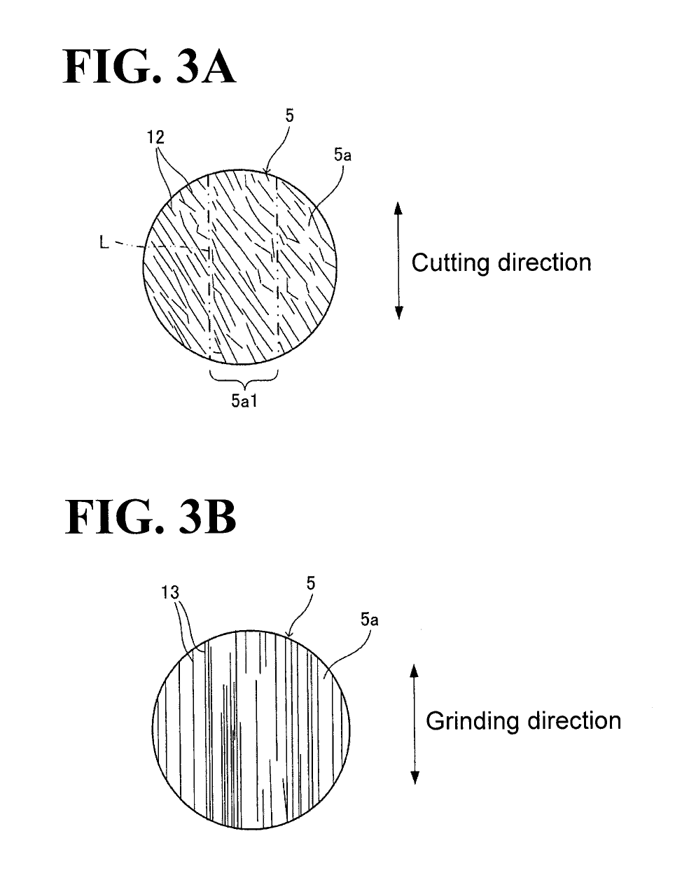

FIG. 3A illustrates exemplary processing marks on the flat portion 5a of the protrusion 5 resulting from cutting, and FIG. 3B illustrates an exemplary processing mark on the flat portion 5a of the protrusion 5 resulting from grinding. The processing mark exemplified in FIG. 3A results from cutting with an end mill, which is an example of the cutter 23. For example, the cutting with the end mill proceeds in its cutting direction (movement direction) and repeats a number of times in a direction perpendicular to the cutting direction. The repeated cutting leaves a plurality of shorter, thin processing marks 12 on the surface of the flat portion 5a of the protrusion 5. The processing marks 12 are inclined relative to imaginary lines L. The imaginary lines L are along the cutting direction of the end mill and define cutting areas 5a1, which correspond to the number of times of the cutting. The processing mark exemplified in FIG. 3B results from grinding with a grinder, which is an example of the grinding device. The grinding with the grinder leaves a plurality of longer, thin processing marks 13 on the surface of the flat portion 5a of the protrusion 5. The processing marks 13 are along the grinding direction of the grinder and approximately parallel to each other.

It is possible to perform flat surface finishing or some other finishing after the cutting or the grinding to eliminate or minimize the processing marks. It should be noted, however, that leaving processing marks ensures that the binder 6 is impregnated in the processing marks, providing a binding function at the portion of contact between the spacer 5 and the magnet 1. This configuration enhances the binding strength between the magnets 1.

### 4. Configuration of Production System for Magnet Lamination

Next, an exemplary configuration of a production system 20 according to this embodiment for the magnet lamination will be described by referring to FIG. 4. The production system 20 for the magnet lamination includes the binder spot applier 21 (corresponding to the first applier), the heating device 22 (corresponding to the first hardener), the cutter 23 (corresponding to the processor), the binder even applier 24 (corresponding to the second applier), the pressurizer 25, and the heating device 26 (corresponding to the second hardener).

The binder spot applier 21 applies the binder 3 in a spotted manner to a plurality of positions on the one surface 2a of the magnet plate 2 of the magnet 1. The spotted manner should not be construed as limiting the manner in which the binder 3 applies the binder 3. Another possible manner is an even manner, in which one application covers some area.

The heating device 22 has a furnace capable of accommodating a magnet plate 2. In the furnace, the heating device 22 heats the magnet plate 2 to harden the binder 3 applied on the one surface 2a of the magnet plate 2 and thus form a protrusion 4 of resin. The heating device should not be construed as limiting the hardener to harden the binder 3. For example, when the binder 3 is an ultraviolet curable binder, it is possible to use an ultraviolet irradiator instead of the heating device 22. That is, when the nature of the binder 3 is that the binder 3 hardens using an external energy source such as radiation, heat, and moisture in the air, the hardener may supply an external energy source corresponding to the kind of the binder.

An example of the cutter 23 is an end mill that cuts the protrusion 4 into any desired shape to form the spacer 5. In this embodiment, the end mill cuts an upper portion of the protrusion 4 to form a protrusion 5 (spacer 5) that has a predetermined height as measured from the one surface 2a of the magnet plate 2. The cutter should not be construed as limiting the processor to process the protrusion 4. Another possible example is a grinder, as described above. It is also possible to use a device to perform processing other than cutting and grinding.

The binder even applier 24 applies the binder 6 in an even manner over the one surface 2a of the magnet plate 2 on which the spacers 5 are formed. The even manner should not be construed as limiting the manner in which the binder 3 applies the binder 6. Another possible manner is a spotted manner, in which the binder 3 is applied to a plurality of positions.

An example of the pressurizer 25 is a press that has a pair of pressure holders (not illustrated). The pair of pressure holders apply pressure to the plurality of magnets 1 laminated on top of each other through the binders 6 so as to compress the plurality of magnets 1 in the directions in which the plurality of magnets are laminated.

Under the pressure of the pressurizer 25, the heating device 26 heats the plurality of magnets 1 laminated on top of each other through the binder 6 so as to harden the binder 6 and thus form the binder layer 7. Thus, the magnet lamination 10, which is made up of the plurality of laminated magnets 1 bound to each other through the binder layers 7, is formed. Similarly to the heating device 22, the heating device 26 should not be construed as limiting the hardener to harden the binder 6. It is possible to use an ultraviolet irradiator or any other device that supplies an external energy source corresponding to the kind of the binder. It is also possible to use a single device to serve both as the heating device 26 and the heating device 22.

It is possible to provide a controller in the production system 20 for the magnet lamination so that the controller performs integrated control of the above-described devices to automatically produce the magnet lamination 10. In this case, it is possible to provide a belt conveyor or other means of conveyance between the above-described devices to convey the magnets. Alternatively, an operator may convey the magnets and handle the above-described devices manually. While in the above description the above-described devices are incorporated in a system, it is also possible to provide a single apparatus with the functions of the above-described devices.

### 5. Details of Control Performed by the Controller

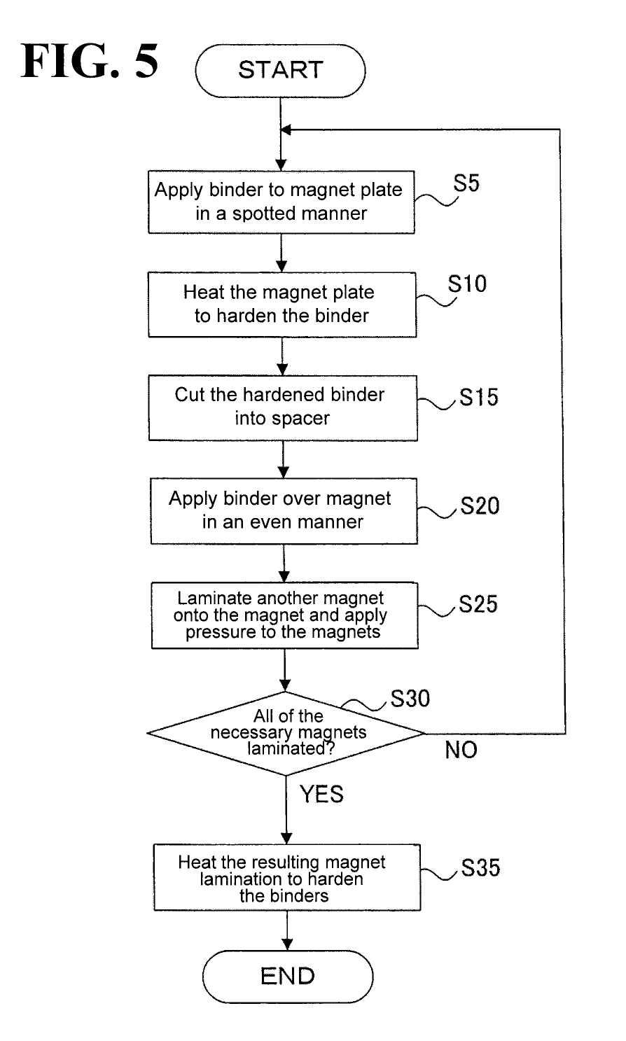

Next, by referring to FIG. 5, description will be made with regard to an example of control performed by the above-described controller in a case where the controller is provided in the production system 20 for the magnet lamination.

First, at step S5, the controller controls the binder spot applier 21 to apply the binder 3 in a spotted manner to a plurality of positions on one surface 2a of the magnet plate 2. When step S5 ends, the processing moves to step S10.

At step S10, the controller controls the heating device 22 to heat the magnet plate 2 so as to harden a plurality of binders 3 applied on the one surface 2a of the magnet plate 2 and thus form a plurality of protrusions 4 of resin. When step S10 ends, the processing moves to step S15.

At step S15, the controller controls the cutter 23 to cut the plurality of protrusions 4 into a plurality of protrusions 5 (spacers 5) of equal heights as measured from the one surface 2a of the magnet plate 2. Thus, the magnet 1 is prepared. When step S15 ends, the processing moves to step S20.

At step S20, the controller controls the binder even applier 24 to apply the binder 6 in an even manner over the one surface 2a of the magnet plate 2 of the magnet 1. When step S20 ends, the processing moves to step S25.

At step S25, the controller controls a suitable device to superpose a new magnet 1 onto the binder 6 applied on the old magnet 1 so as to laminate the new magnet 1 on the old magnet 1. Then, the controller controls the pressurizer 25 to apply pressure to the lamination of the two magnets 1 so as to compress the lamination in the directions in which the two magnets 1 are laminated. The pressure causes the binder 6 to be pressed, making the distance between the two magnets 1 approximately the same as the thickness of the spacers 5. In other words, the spacers 5 (which are formed at step S35, described later) define the thickness of the binder layer 7 in the directions in which the two magnets are laminated. When step S25 ends, the processing moves to step S30.

At step S30, the controller determines whether all of the magnets 1 necessary for production of the magnet lamination 10 have been laminated. When not all of the magnets 1 have been laminated yet, the determination is on the negative side (step S30: NO), and the processing repeats step S5 and later steps. When all of the magnets 1 have been laminated, the determination is on the affirmative side (step S30: YES), and the processing returns to step S35.

At step S35, the controller controls the heating device 26 to heat the magnet lamination, in which a desired number of magnets 1 are laminated on top of each other, under the pressure of the pressurizer 25, so as to harden the binders 6 between the magnets 1 and thus form the binder layers 7. Thus, the magnet lamination 10, in which the plurality of magnets 1 are bound to each other through the binder layers 7, is produced. Then, the flow of control ends.

At step S5, it is possible to, for example, adjust the amount of application of the binder 3 to the one surface 2a of the magnet plate 2 so as to make the heights of the heat-hardened protrusions 4 approximately the same. In this case, the protrusions 4 are usable, as they are, as spacers, and thus it is possible to omit the cutting at step S15. When the cutting at step S15 is omitted, the cutter 23 is unnecessary.

In the above description, the spacers 5 and the binder layer 7 correspond to the means for binding adjacent magnets among the plurality of magnets to each other and for defining a gap between the adjacent magnets.

### 6. Advantageous Effects of the Embodiment

As has been described hereinbefore, the magnet 1 according to this embodiment includes a plurality of resin protrusions 5 (or protrusions 4) at a plurality of positions on at least one surface 2a of the magnet plate 2. With this configuration, at the time of laminating the plurality of magnets 1 using the binder 6, the plurality of protrusions 5 formed on the one surface of the magnet 1 serve as spacers to define the thickness of the binder layer 7 in the direction in which the plurality of magnets 1 are laminated. This improves the accuracy of the thickness of the binder layer 7.

Since the protrusions 5 are made of resin, all of the elements (the protrusions 5 and the binder layers 7) interposed between the magnets 1 in the final product, the magnet lamination 10, are resin elements. This configuration ensures electrical insulation between the magnets 1. This configuration also eliminates the need for foreign matter such as fine glass balls to be mixed in the binder in an attempt to improve the accuracy of the thickness of the binder layer 7. This leads to reductions in cost and facilitates parts management. Additionally, since the protrusions 5 are made of resin, the protrusions 5 are more readily processed, that is, the protrusions 5 can be shaped by cutting, grinding, or any other processing with higher degrees of accuracy and freedom. This configuration ensures that the thickness of the binder layer 7 is defined more reliably, and facilitates changes to be made to the shapes of the protrusions 5 (spacers 5).

The resin of the protrusions 5 results from hardening of the binder 3. This configuration eliminates the need for preparing additional spacers of glass or any other material in order to form the protrusions 5, and the need for preparing a dedicated device to mount the spacers on the surface 2a of the magnet 1.

It is particularly noted that in this embodiment, the plurality of protrusions 5 (or the protrusions 4) have approximately equal heights as measured from the surface 2a. This configuration ensures that the thickness of the binder layer 7 is defined more accurately in the direction in which the plurality of magnets are laminated.

It is particularly noted that in this embodiment, the protrusion 5 has the flat portion 5a, and that on the flat portion 5a, the processing mark 12 or 13, which results from processing by the cutter 23 or another device, is formed. This configuration provides the following advantageous effects. Specifically, leaving the processing mark 12 or 13 on the flat portion 5a of the spacer 5 ensures that the binder 6 is impregnated in the processing mark 12 or 13, providing a binding function at the portion of contact between the spacer 5 and the magnet 1. This configuration enhances the binding strength between the magnets 1.

Also in this embodiment, it is possible to use the same kind of resin for the spacer 5 and the binder layer 7. In other words, it is possible to use the same kind of resin for the binder 3 and the binder 6. This configuration reduces cost and facilitates management. This configuration also makes thermal expansivity approximately uniform throughout the spacer 5 and the binder layer 7, and thus eliminates or minimizes degradation of the binding strength between the magnet 1 and other occurrences that can be caused by change in temperature of the magnet lamination 10.

It is particularly noted that in this embodiment, the binder layer 7 cover the plurality of protrusions 5. This configuration ensures that the binder layer 7, which is made of the binder 6, can be formed over a wider area. This, in turn, further improves the binding strength between the magnets 1.

### 7. Modifications

Modifications will be described below.

### 7-1. Modifications of Shape of the Spacer

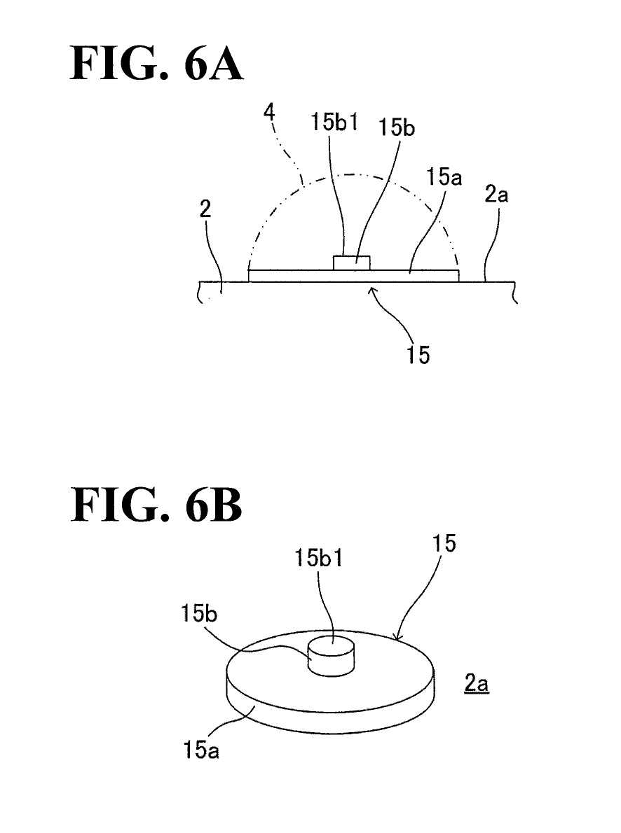

In the above-described embodiment, the spacer 5 has an approximately circular plate shape. This configuration, however, should not be construed in a limiting sense. FIGS. 6A and 6B illustrate other possible shapes of the spacer 5.

As illustrated in FIGS. 6A and 6B, a spacer 15 (protrusion 15) according to this modification includes a larger-diameter portion 15a and a smaller-diameter portion 15b. The larger-diameter portion 15a has an approximately circular plate shape. The smaller-diameter portion 15b has an approximately circular plate shape on the larger-diameter portion 15a. A plurality of spacers 15 have approximately equal heights as measured from a magnet surface 2a of the smaller-diameter portion 15b. Each of the spacers 15 has a flat portion 15b1 on the upper end of the smaller-diameter portion 15b. On the flat portion 15b1, the processing mark 12 or 13 is formed.

In this modification, the area of contact between the spacer 15 and the magnet 1 (that is, the area of the flat portion 15b1) is smaller than in the above-described embodiment. This configuration increases the area of binding implemented by the binder 6 (the binder layer 7). This, in turn, further improves the binding strength between the magnets 1.

### 7-2. Other Modifications of Shape of the Spacer

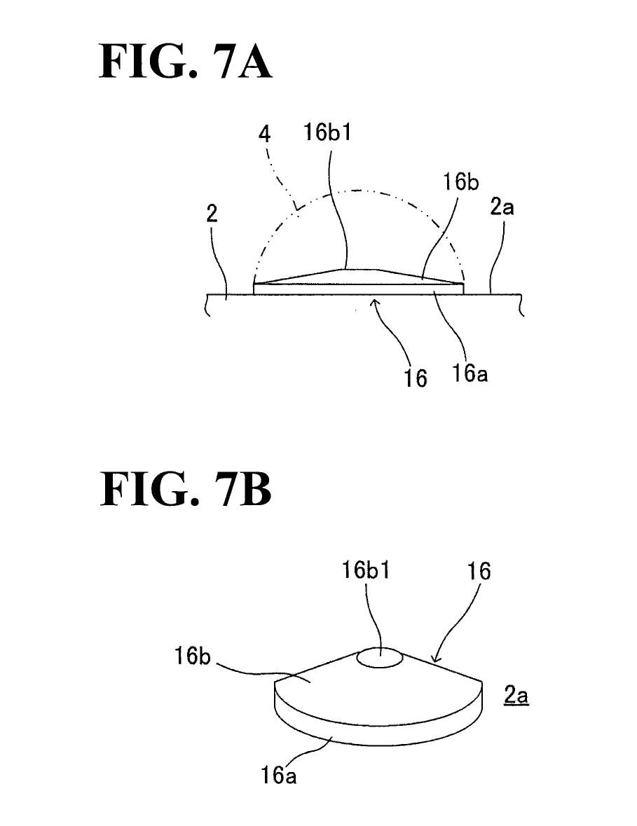

FIGS. 7A and 7B illustrate other possible shapes of the spacer 5. As illustrated in FIGS. 7A and 7B, a spacer 16 (protrusion 16) according to this modification includes a base portion 16a and a truncated cone portion 16b. The base portion 16a has an approximately circular plate shape. The truncated cone portion 16b is on the base portion 16a and has an approximately truncated cone shape that is tapered toward the top end of the spacer 16. A plurality of spacers 16 have approximately equal heights as measured from the magnet surface 2a of the truncated cone portion 16b. Each of the spacers 16 has a flat portion 16b1 on the upper end of the truncated cone portion 16b. On the flat portion 16b1, the processing mark 12 or 13 is formed.

In this modification as well, the area of contact between the spacer 16 and the magnet 1 (that is, the area of the flat portion 16b1) is smaller than in the above-described embodiment. This configuration increases the area of binding implemented by the binder 6 (the binder layer 7). This, in turn, further improves the binding strength between the magnets 1.

The spacer may have any of other various shapes. Other examples include, but are not limited to, a polygonal shape, a linear shape, and a cross shape.

### 7-3. Modifications of Number and Arrangement of the Spacers

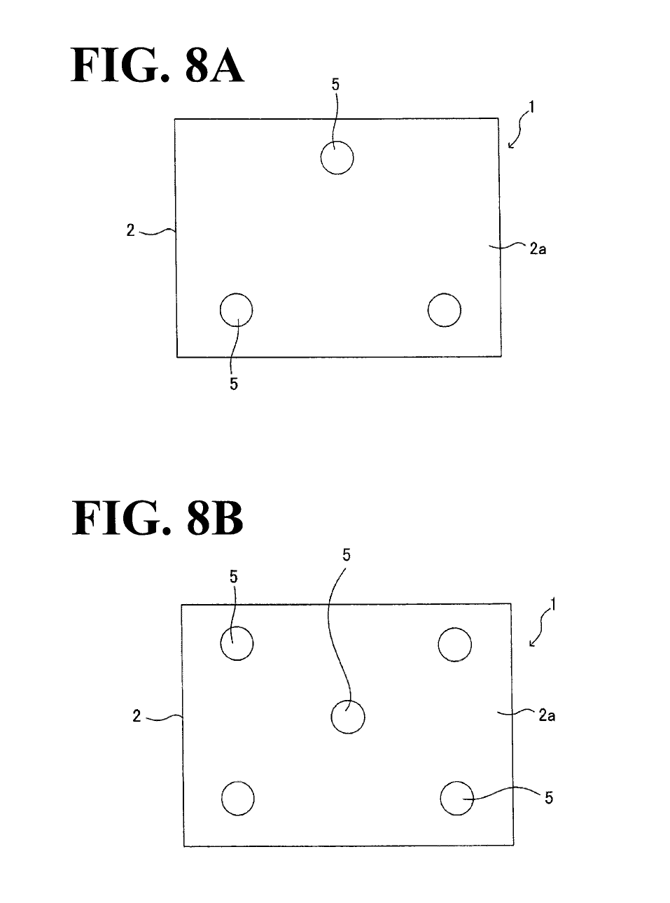

While in the above-described embodiment the spacers 5 are arranged at four positions respectively adjacent to the four corners of the magnet plate 2, this should not be construed as limiting the number and arrangement of the spacers 5. For example, as illustrated in FIG. 8A, three spacers 5 may form a triangle (such as an equilateral triangle and an isosceles triangle) on the surface 2a of the magnet plate 2 of the magnet 1, with the three spacers 5 at the apexes of the triangle. For another example, as illustrated in FIG. 8B, five spacers 5 may be arranged on the surface 2a of the magnet plate 2 of the magnet 1, with four of the spacers 5 at four positions respectively adjacent to the four corners of the magnet plate 2 and the other spacer 5 approximately at the center of the magnet plate 2. Insofar as the number of the spacers 5 is equal to or more than two, any number of spacers 5 may be arranged in any of other various manners.

As used herein, the terms “perpendicular”, “parallel”, and “plane” may not necessarily mean “perpendicular”, “parallel”, and “plane”, respectively, in a strict sense. Specifically, the terms “perpendicular”, “parallel”, and “plane” mean “approximately perpendicular”, “approximately parallel”, and “approximately plane”, respectively, taking design-related and production-related tolerance and error into consideration.

Also, when the terms “same”, “equal”, and “different” are used in the context of dimensions or shapes of external appearance, these terms may not necessarily mean “same”, “equal”, and “different”, respectively, in a strict sense. Specifically, the terms “same”, “equal”, and “different” mean “approximately same”, “approximately equal”, and “approximately different”, respectively, taking design-related and production-related tolerance and error into consideration.

Otherwise, the above-described embodiments and modifications may be combined in any manner deemed suitable.

Obviously, numerous modifications and variations of the present disclosure are possible in light of the above teachings. It is therefore to be understood that within the scope of the appended claims, the present disclosure may be practiced otherwise than as specifically described herein.

What is claimed as new and desired to be secured by Letters Patent of the United States is:

1. A magnet applicable to a movable electrical machine and comprising a plurality of resin protrusions at a plurality of positions on a surface of the magnet.

2. The magnet according to claim 1, wherein the plurality of protrusions comprise approximately identical heights from the surface of the magnet.

3. The magnet according to claim 2, wherein the plurality of protrusions each comprise a flat portion with a processing mark on the flat portion.

4. A magnet lamination applicable to a movable electrical machine, the magnet lamination comprising:
a plurality of laminated magnets;
a binder layer comprising a first resin disposed between adjacent magnets among the plurality of magnets to bind the adjacent magnets to each other; and
a plurality of spacers each comprising a second resin disposed at a plurality of positions between the adjacent magnets to define a thickness of the binder layer in a direction in which the plurality of magnets are laminated.

5. The magnet lamination according to claim 4, wherein the first resin and the second resin comprise an identical kind of resin.

6. The magnet lamination according to claim 4, wherein the binder layer covers the plurality of spacers.

7. A method for producing a magnet lamination applicable to a movable electrical machine, the method comprising:
applying a first binder to a plurality of positions on a surface of a first magnet;
hardening the first binder;
processing the hardened first binder into a predetermined shape to form a spacer;
applying a second binder to the surface of the first magnet;
placing a second magnet on the surface of the first magnet to form a lamination of the first magnet and the second magnet, and applying pressure to the lamination; and
hardening the second binder between the first magnet and the second magnet.

8. A production system for a magnet lamination applicable to a movable electrical machine, the production system comprising:
a first applier configured to apply a first binder to a plurality of positions on a surface of a first magnet;
a first hardener configured to harden the first binder;
a processor configured to process the hardened first binder into a predetermined shape so as to form a spacer;
a second applier configured to apply a second binder to the surface of the first magnet;
a pressurizer configured to place a second magnet on the surface of the first magnet so as to form a lamination of the first magnet and the second magnet, and configured to apply pressure to the lamination; and
a second hardener configured to harden the second binder between the first magnet and the second magnet.

9. A magnet lamination applicable to a movable electrical machine, the magnet lamination comprising:
a plurality of magnets laminated on top of each other; and
means for binding adjacent magnets among the plurality of magnets to each other and for defining a gap between the adjacent magnets.

10. The magnet lamination according to claim 5, wherein the binder layer covers the plurality of spacers.
